(19) United States
(12) Patent Application Publication
(10) Pub. No.: US 2010/0282221 A1
(43) Pub. Date: Nov. 11, 2010

(54) INTERNAL COMBUSTION ENGINE AND VEHICLE EQUIPPED WITH SUCH ENGINE

(75) Inventor: Armel Le Lievre, Montesson (FR)

Correspondence Address: Polster, Lieder, Woodruff & Lucchesi, L.C., 12412 Powerscourt Dr. Suite 200, St. Louis, MO, 63131-3615, US

(73) Assignee: PEUGEOT CITROEN AUTOMOBILES SA, Velizy Villacoublay (FR)

(21) Appl. No.: 12/812,669

(22) PCT Filed: Jan. 15, 2009
(86) PCT No.: PCT/FR09/50058

§ 371 Date: Jul. 13, 2010

(30) Foreign Application Priority Data
Jan. 18, 2008 (FR) 0850307

(51) Int. Cl. F02B 33/00

(52) U.S. Cl. 123/559.1

(57) ABSTRACT

The invention relates to an internal combustion engine (1) that includes an inlet circuit (3) for oxidant air, an exhaust circuit (6), a compressor (4) having an input shaft (41), capable of increasing the air pressure in the inlet circuit when the input shaft thereof is rotated, an engine output shaft (21), a means for selective coupling (42) between the engine output shaft and the compressor input shaft, a Rankine cycle circuit (7) with an evaporator (71) in thermal contact with the exhaust circuit and provided with an expansion member (72) driven by the gas from the evaporator, characterised in that it further comprises a means for selective coupling (44) between the expansion member (72) and the input shaft (41) of the compressor.

### REFERENCE TO RELATED APPLICATIONS

The present application is the US national stage under 35 U.S.C. §371 of International Application No. PCT/FR2009/050058 which claims the priority of French application 0850307 filed on Jan. 18, 2008, the content of which (text, drawings and claims) is incorporated here by reference.

### BACKGROUND

The invention relates to internal combustion engines and in particular to the optimization of the energy efficiency of an internal combustion engine for automotive vehicles.

To limit the fuel consumption of automotive vehicles, numerous research studies are aimed at increasing their energy efficiency. One known method for increasing the energy efficiency of an internal combustion engine consists in supercharging air at the inlet line in order to increase the quantity of oxidizer in the combustion chamber. A first supercharge solution consists in installing a volumetric compressor in the inlet line. The compressor is driven by the engine crankshaft through a belt. Such compressor delivers a significant supercharge pressure at low engine speed, with a reduced response time when the load varies. A second supercharge solution consists in using a turbo compressor. The turbo compressor has an expansion turbine which is driven by the exhaust gas. The expansion turbine turns a compression turbine for the inlet air. The energy of the exhaust gas is in this way recuperated to increase the inlet pressure.

However, the energy efficiency is only marginally increased because the expansion turbine creates a pressure drop in the exhaust gas flow. In case of load variation, the inertia of the turbo compressor generates a response time problem: the increase of the inlet pressure is delayed relative to the load increase command. Therefore, supercharging must be limited to partial loading and low speed, which lowers the efficiency and increases harmful emissions.

Document FR-2 500 536 describes an internal combustion engine equipped with a volumetric inlet compressor. The engine output shaft is connected to a first pulley through the intermediary of a first commanded clutch. The first pulley drives a second pulley through the intermediary of a belt. The second pulley is coupled to the drive shaft of the volumetric compressor through the intermediary of a second commanded clutch. The internal combustion engine is equipped with a Rankine cycle circuit. The Rankine cycle circuit comprises a heat exchange vessel through which the exhaust gas of the internal combustion engine passes. Another fluid heat transfer circuit passes through the heat exchange vessel. The heat transfer fluid enters the vessel in liquid phase and is vaporized by the heat supplied by the exhaust gas. The vaporized heat transfer fluid drives the rotation of a turbine. The heat transfer fluid passing through the circuit is reheated on the one side by the engine coolant and on the other side by the engine oil. The turbine is coupled to a third pulley through the intermediary of a third commanded clutch. The third pulley turns a fourth pulley through the intermediary of a belt. The fourth pulley is coupled to the engine output shaft through the intermediary of a fourth commanded clutch, so that the turbine can transmit the engine torque to the output shaft.

This type of engine has drawbacks. This engine requires a large number of mechanical components, which burdens the production cost and increases the space occupied in the engine compartment. Besides, such an engine requires controlling several clutches without otherwise optimizing the combustion for the whole operational cycle of the engine. Moreover, the fluid heat transfer circuit is relatively complex and voluminous. Furthermore, the location of the vessel in the exhaust circuit is not optimized and this type of engine is likely to emit large quantities of nitrogen oxides.

### BRIEF SUMMARY

The goal of the invention is to resolve one or more of these drawbacks. The invention relates to an internal combustion engine, comprising:
an inlet circuit for combustive air;
an exhaust circuit;
a compressor with an input shaft, suitable to increase the air pressure in the inlet circuit when the input shaft is rotated;
an engine output shaft;
selective coupling means between the engine output shaft and the compressor input shaft;
a Rankine cycle circuit equipped with an evaporator in thermal contact with the exhaust circuit and equipped with an expansion element driven by the gas coming from the evaporator; and
selective coupling means between the expansion element and the compressor input shaft.

According to one variant, the selective coupling means comprises first and second overrunning clutches mounted on the compressor input shaft.

According to another variant, the engine has an intermediate shaft; wherein, the intermediate shaft and the compressor input shaft are respectively the drive shaft and the driven shaft of the first overrunning clutch, while the intermediate shaft is rotated by the engine output shaft.

According to another variant, the intermediate shaft is coupled to the engine output shaft through the intermediary of an electromagnetic clutch.

According to another variant, the expansion element is a turbine.

According to one variant, the expansion element comprises an output shaft; this output shaft and the compressor input shaft are respectively the drive shaft and the driven shaft of the second overrunning clutch.

According to another variant, the exhaust circuit comprises a purification element arranged in the exhaust gas flow, and in which the evaporator is arranged in thermal contact with the exhaust circuit downstream of the purification element.

According to another variant, the Rankine cycle circuit comprises a pump supplying the evaporator with fluid to be vaporized and a condenser connected between the pump and the expansion element.

According to yet another variant, the engine comprises an exhaust gas recycling circuit connecting the exhaust circuit with the inlet circuit, the exhaust gas recycling circuit is connected with the exhaust circuit downstream of the thermal contact between the evaporator and the exhaust circuit.

According to a variant, the air inlet circuit passes through a cooling radiator installed downstream of the compressor.

The invention also relates to an automotive vehicle with an engine as described above and a cabin ventilation system. The engine has a valve which can place one exit of the expansion element selectively in communication with the condenser or a heat exchanger in contact with the ventilation system.

### BRIEF DESCRIPTION OF THE SEVERAL VIEWS OF THE DRAWINGS

Other characteristics and advantages of the invention will become clear from the following description, given as an example and by no means limiting, with reference to the attached drawings, in which:

FIG. 1 illustrates schematically an internal combustion engine according to a first implementation mode of the invention;

FIG. 2 illustrates schematically an internal combustion engine according to a second implementation mode of the invention.

FIG. 3 illustrates schematically an internal combustion engine according to a third implementation mode of the invention.

### DETAILED DESCRIPTION

An internal combustion engine 1 comprises a compressor 4 and a Rankine cycle circuit 7 equipped with an evaporator 71 in thermal contact with the exhaust circuit 6. The engine output shaft can be coupled or decoupled selectively from the compressor input shaft 41. The Rankine cycle circuit has an expansion element 72 driven by the gas coming from the evaporator. The expansion element can be coupled or decoupled selectively from the compressor input shaft.

In practice the invention makes it practical to increase the energy efficiency of the engine by reducing the load on its output shaft. In addition, the invention reduces the number of mechanical components by reducing the number of clutches needed, consequently reducing also the complexity of the commands for these clutches.

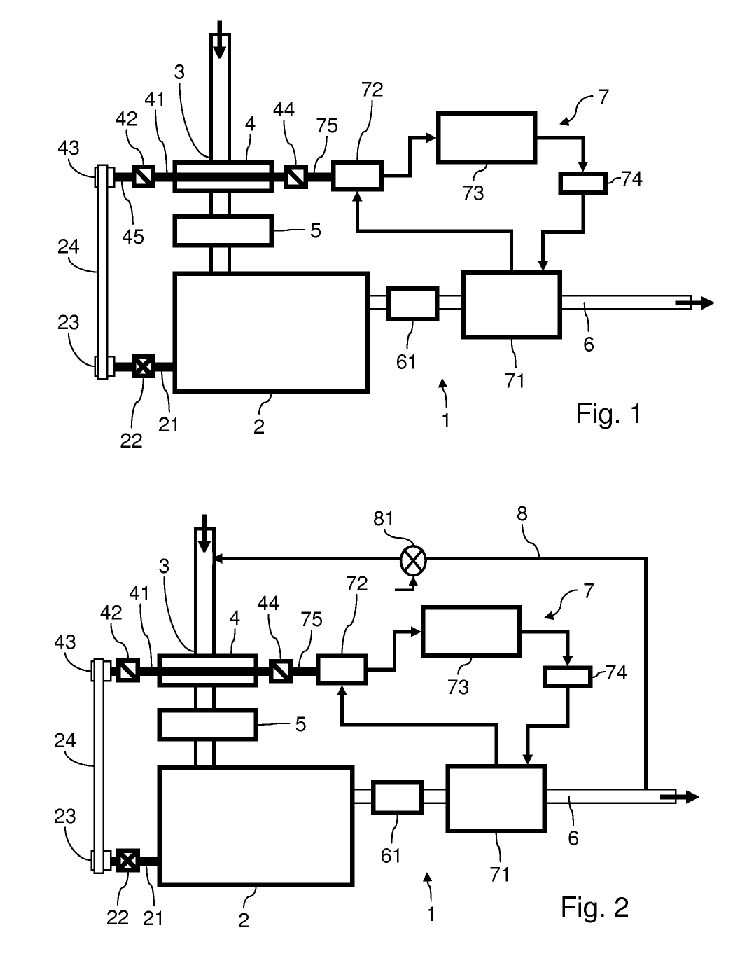

FIG. 1 illustrates in more detail a first implementation mode of an internal combustion engine 1 according to the invention. Engine 1 comprises an engine block 2 with an inlet circuit 3 of combustive air and an exhaust circuit 6 of combustion gas. Engine 1 comprises a compressor 4 mounted in the inlet circuit 3. Compressor 4 has an input shaft 41. When input shaft 41 is rotated, compressor 4 increases the air pressure in inlet circuit 3. Compressor 4 can be, for instance, a volumetric compressor, a turbine compressor or a spiral compressor. The input shaft 41 has two extremities on which first and second selective coupling means 42 and 44 are mounted.

The inlet circuit 3 ends in a combustion chamber of engine block 2. The combustion chamber communicates with the exhaust circuit 6. The exhaust circuit 6 is in thermal contact with an evaporator 71 of a Rankine cycle circuit 7. A heat exchanger can also be mounted in the exhaust circuit 6 in order to transfer thermal energy towards evaporator 71. The Rankine cycle circuit 7 comprises furthermore an expansion element 72 driven by gas coming from the evaporator 71. The expansion element 72 can be executed in the form of a turbine or a volumetric expansion device known to a person skilled in the art. The expansion element 72 has an output shaft 75 connected to coupling means 44. In this way, the coupling means 44 selectively connects output shaft 75 and input shaft 41.

The engine block 2 has an output shaft 21, typically formed from the crankshaft of a piston engine. Output shaft 21 is connected to coupling means 42. The coupling means 42 selectively connects output shaft 21 and input shaft 41.

In this way, the energy supplied by the expansion element 72 is recuperated to compress the combustive gas at the inlet instead of applying engine torque to the output shaft 21. On the other hand, the Rankine loop cycle 7 is not generating a pressure drop in the exhaust circuit 6, which is favorable for the energy efficiency of the engine.

The resistive torque on output shaft 21 can be reduced by decoupling shafts 75 and 41: in particular when the engine block 2 is cold, the Rankine circuit 7 is not generating sufficient energy and insufficient drive torque is generated on shaft 75. In this case, shafts 75 and 41 are advantageously decoupled to reduce the resistive torque on output shaft 21. During this time, shafts 21 and 41 are advantageously coupled so that overpressure is generated by compressor 4 in inlet circuit 3.

The resistive torque on output shaft 21 can also be reduced by decoupling shafts 21 and 41, in particular when the engine block 2 is hot. The Rankine circuit 7 then generates sufficient energy, and sufficient drive torque is generated at shaft 75. In this case, shafts 21 and 41 are advantageously decoupled to reduce the resistive torque on shaft 21. During this time, shafts 41 and 75 are advantageously coupled so that overpressure is generated by compressor 4 in inlet circuit 3.

The resistive torque on output shaft 21 can also be reduced by coupling shafts 21, 41 and 75, specifically during an intermediate phase of temperature rise of engine block 2 or in all cases where the drive torque generated at shaft 75 does not provide sufficient pressure at compressor 4. In this case, the torques applied by shafts 21 and 75 on shaft 41 are accumulated: the resistive torque on shaft 21 is then reduced (because of the torque supplied by shaft 75) and the overpressure generated at the inlet by compressor 4 is sufficient. An elevated supply overpressure is also generated by partial loading of the engine, which favors its energy efficiency and the reduction of polluting emissions.

The invention is particularly advantageous in engines with stratified direct injection.

Advantageously, in the illustrated example, the coupling means 42 and 44 are formed respectively by first and second overrunning clutches mounted on the extremities of input shaft 41. In practice, the use of overrunning clutches eliminates the need to command coupling means 42 and 44, since the decoupling between shaft 41 and shafts 21 and 75 occurs automatically when either shaft 21 or shaft 75 is no longer supplying sufficient drive torque.

Shaft 75 is the drive shaft of the second overrunning clutch. Shaft 41 is the driven shaft of the second overrunning clutch.

The engine 1 has an intermediate shaft 45 which is the drive shaft of the first overrunning clutch. Shaft 41 is the driven shaft of the first overrunning clutch. The intermediate shaft 45 is driven by output shaft 21, through the intermediary of pulley 43, belt 24, pulley 23 and electromagnetic coupling 22.

When one of shafts 45 or 75 rotates slower than shaft 41, it is decoupled by the overrunning clutch. In this way, the faster rotating shaft of shafts 45 or 75 will be coupled to shaft 41 in order to drive it. When the torques supplied by shafts 45 and 75 are close, these shafts synchronize to drive shaft 41. In order to facilitate the synchronization, the Rankine loop cycle 7 can be adjusted appropriately.

The electromagnetic clutch 22 enables suppression of the resistive torque of pulleys 23 and 43, belt 24 and intermediate shaft 45, in particular when sufficient torque is generated on shaft 75.

The Rankin loop circuit 7 is a closed loop circuit. A two-phase Rankine loop can be created by using a heat transfer fluid in known manner. The Rankine loop circuit 7 comprises the evaporator 71 supplying the vaporized gas to the expansion element 72. The output of the expansion element 72 is connected in known manner to a condenser 73, for liquefying the fluid coming from the expansion element 72. The output of condenser 73 is connected to the inlet of vaporizer 71 through the intermediary of pump 74 supplying vaporizer 71 with liquefied fluid.

Engine 1 comprises a purification element 61′ installed in the flow of exhaust gas. This purification element 61 is an after treatment device and can typically include a particulate filter, a carbon monoxide catalyst, a nitrogen oxide catalyst, a catalyst of unburned hydrocarbons or a nitrogen oxide trap. The evaporator 71 is placed in thermal contact with the exhaust circuit downstream of this purification element 61. In this way, the efficiency of the purification element 61 is optimal since it is treating exhaust gas that has not been cooled by the evaporator 71. In addition, the evaporator 71 does not add thermal inertia that can delay the priming of the catalysts of purification element 61. In addition, purification element 61 performs exothermic reactions (oxidation of unburned hydrocarbons and carbon monoxide), the energy of which is recuperated by evaporator 71.

The engine 1 comprises advantageously a radiator of supercharged air 5 mounted in the inlet circuit 3 between compressor 4 and the combustion chamber. In this way, a larger quantity of combustive gas can be introduced in the combustion chamber for each cycle of the engine.

As illustrated in FIG. 2, the engine can comprise a recycling circuit for exhaust gas or EGR 8 in order to assist with the reduction of nitrogen oxide emissions. The EGR circuit 8 connects the exhaust circuit 6 with the inlet circuit 3 through the intermediary of valve 81. The EGR circuit ends in the exhaust circuit 6 downstream of the thermal contact between the evaporator 71 and the exhaust circuit 6. In this way, the exhaust gas passing through the EGR circuit 8 is cooled by the evaporator, which eliminates the need to install a dedicated cooling radiator in the EGR circuit 8. In addition, all the exhaust gas passes through the evaporator 71 before reaching the EGR circuit 8, which optimizes the energy efficiency of the Rankine loop circuit 7. The illustrated implementation mode corresponds with a low pressure EGR circuit, in other words the EGR circuit 8 is connected to the inlet circuit 3 upstream of compressor 4. If in addition, line 8 ends downstream of the purification element 61, the reliability of valve 81 is improved because it is traversed by cooled and purified gas.

It can be envisaged that in the implementation mode of FIG. 2 compressor 4 is not driven by the output shaft 21 of the engine block.

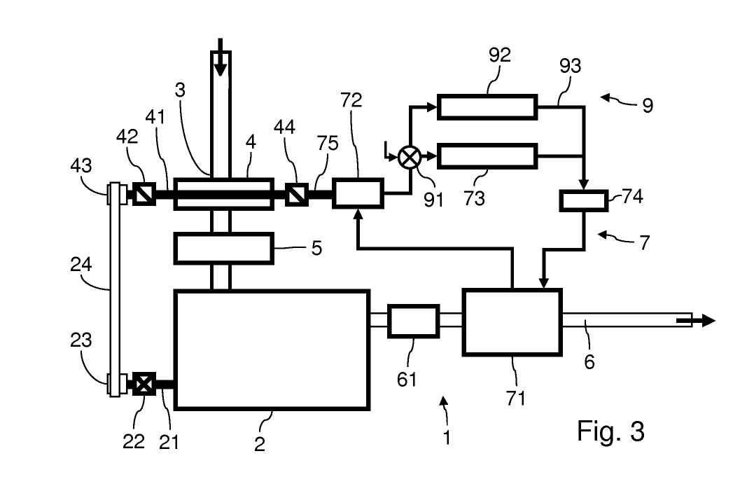

In the implementation mode illustrated in FIG. 3, an air reheating bypass 9, directed to the cabin of the vehicle, interacts with the Rankine loop circuit 7. The bypass 9 includes a heat exchanger 92 in which thermal contact is made between line 93 of circuit 7 and an air flow line (not shown) directed towards the blowers in the cabin. The bypass 9 includes a three-way valve 91, which puts the outlet of the expansion element 72 selectively in communication with condenser 73 or with heat exchanger 92. In this way, when cold air must be reheated before being injected in the cabin, the fluid leaving the expansion element 72 can be directed by valve 91 into line 93. In this way, condenser 73 is bypassed and heat exchanger 92 performs the function of condenser.

It can be envisaged that in the implementation mode illustrated in FIG. 3 compressor 4 is not driven by the output shaft 21 of the engine block 2.

1. Internal combustion engine comprising:
an inlet circuit for combustive air;
an exhaust circuit;
a compressor with a input shaft, suitable for increasing the air pressure in the inlet circuit when the input shaft is rotated;
an engine output shaft;
selective coupling means between the engine output shaft and the compressor input shaft;
a Rankine cycle circuit equipped with an evaporator in thermal contact with the exhaust circuit and equipped with an expansion element driven by the gas coming from the evaporator; and
selective coupling means between the expansion element and the compressor input shaft.

2. The engine according to claim 1, in which said selective coupling means comprises first and second overrunning clutches mounted on the compressor input shaft.

3. The engine according to claim 2, comprising an intermediate shaft wherein the intermediate shaft and the compressor input shaft are respectively the drive shaft and the driven shaft of the first overrunning clutch, while the intermediate shaft is driven by the engine output shaft.

4. The engine according to claim 3, in which the intermediate shaft is coupled to the engine output shaft through the intermediary of an electromagnetic clutch.

5. The engine according to claim 1, in which the expansion element is a turbine.

6. The engine according to claim 2, in which the expansion element comprises an expansion element output shaft, the expansion element output shaft and the compressor input shaft are respectively the drive shaft and the driven shaft of the second overrunning clutch.

7. The engine according to claim 1, in which the exhaust circuit comprises a purification element installed in the exhaust circuit, and in which the evaporator is in thermal contact with the exhaust circuit downstream of the purification element.

8. The engine according to claim 1, in which the Rankine cycle circuit comprises a pump supplying the evaporator with liquid to be vaporized and a condenser connected between the pump and the expansion element.

9. The engine according to claim 1, and further comprising an exhaust gas recycling circuit connecting the exhaust circuit with the inlet circuit; the exhaust gas recycling circuit ending in the exhaust circuit downstream of the thermal contact between the evaporator and the exhaust circuit.

10. The engine according to claim 1, in which the air inlet circuit passes through a cooling radiator installed downstream of the compressor.

11. An automotive vehicle comprising an engine according to claim 1 and a cabin ventilation circuit; the engine comprising a valve which puts one outlet of the expansion element selectively in communication with the condenser or with a heat exchanger in contact with the ventilation circuit.
